(19) United States
(12) Patent Application Publication
(10) Pub. No.: US 2014/0225859 A1
(43) Pub. Date: Aug. 14, 2014

(54) MUTUAL CAPACITIVE TOUCH SENSOR PATTERN

(71) Applicant: BROADCOM CORPORATION, Irvine, CA (US)

(72) Inventors: Massoud Badaye, Sunnyvale, CA (US); Sumant Ranganathan, Saratoga, CA (US)

(73) Assignee: Broadcom Corporation, Irvine, CA (US)

(21) Appl. No.: 13/890,524

(22) Filed: May 9, 2013

Related U.S. Application Data
(60) Provisional application No. 61/764,848, filed on Feb. 14, 2013.

(51) Int. Cl. G06F 3/044

(52) U.S. Cl. CPC G06F 3/044
USPC 345/174

(57) ABSTRACT

Elements are provided that mitigate the effects of at least one of charger noise, display noise, and non-grounding in a capacitive touch panel system. Such elements may include an array of sense lines made up of sense electrodes that are shaped differently from drive electrodes making up an array of drive lines, where the area occupied by the sense electrodes is substantially less than that taken up by the drive electrodes. Additionally, the shape of the sense electrodes, despite mitigating the aforementioned effects of charger noise, display noise, and non-grounding, maintains touch detection sensitivity.

### TECHNICAL FIELD

The technical field of the present disclosure relates to touch screen devices, and in particular, to a mutual capacitive touch sensor pattern that can reduce the effects of noise, while increasing sensitivity.

### BACKGROUND

A touch screen refers to an electronic display that can detect the presence and location of a touch within a display area of the touch screen. A touch/touching generally refers to contact made by a finger, hand, or other body part, but may also refer to contact via objects, such as a stylus. The use of touch screen technology is common in devices such as game consoles and game console controllers, all-in-one computers, tablet computers, and smartphones.

Touch screens allow a user to interact directly with what is being displayed, rather than indirectly with a pointer/cursor controlled by a peripheral control device, such as a mouse. Additionally, that direct interaction may be effectuated without requiring any intermediate device that would need to be held in the hand (other than a stylus, which is optional for most modern touch screens). A device having a touch screen is able to respond to a user's touch, and convey information about that touch to a control circuit of the device. The touch screen of the device is often combined with a generally coextensive display device, such as a liquid crystal display (LCD), to form a user interface for the portable device.

Relative to devices that include a keypad, rollerball, joystick, and/or mouse, a device employing touch screen technology may reduce moving parts, increase durability, increase resistance to contaminants, simplify user interaction, and increase user interface flexibility.

### BRIEF DESCRIPTION OF THE DRAWINGS

For a more complete understanding of example embodiments of the present invention, reference is now made to the following descriptions taken in connection with the accompanying drawings in which:

FIG. 1 is an example schematic representation of a device in which various embodiments may be implemented;

FIG. 2A is a top view of one embodiment of the device of FIG. 1;

FIG. 2B is a cross-sectional view of one embodiment of the device of FIG. 1;

FIG. 3 is a representation of an example mutual capacitance touch panel which may be used in the device of FIG. 1;

FIG. 4 is an example schematic representation of a touch front end which may be used in the device of FIG. 1;

FIG. 5A illustrates a top view of an example mutual capacitance touch panel having a conventional diamond sensor pattern;

FIG. 5B illustrates a close-up view of a unit cell of the example mutual capacitance touch panel of FIG. 5A;

FIG. 6 illustrates a cross section of an example in-cell stack up configuration;

FIG. 7A illustrates a cross section of an example stand-alone single layer sensor;

FIG. 7B illustrates drive and sense electrode connections of the example stand-alone single layer sensor of FIG. 7A; and

FIGS. 8A-8E illustrate example asymmetric sensor patterns in accordance with various embodiments.

### DETAILED DESCRIPTION

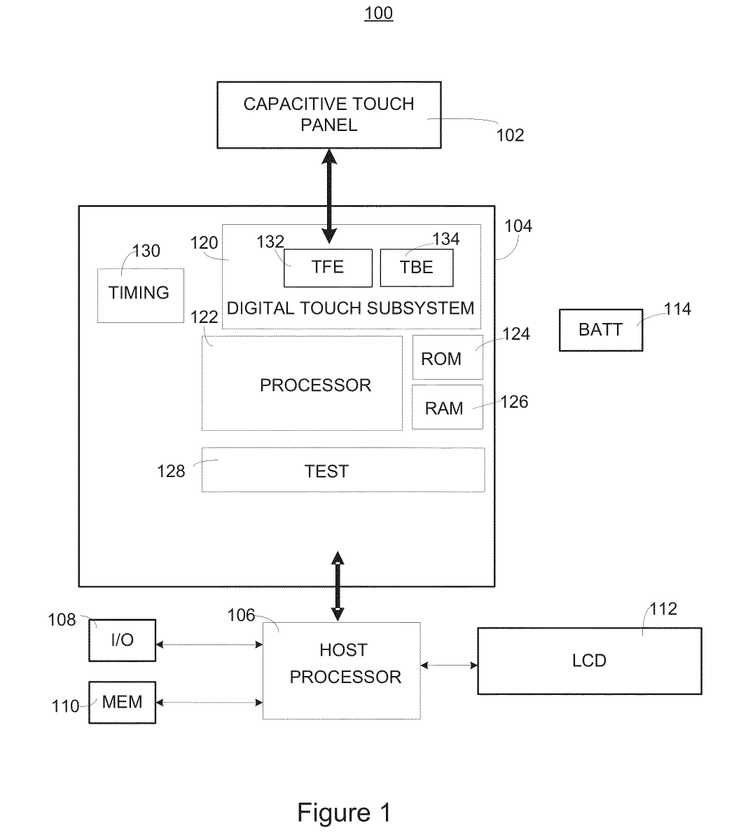

FIG. 1 is a schematic representation of a device 100. The device 100 may be any one of a variety of portable or fixed devices including, but not limited to, a smartphone, personal digital assistant (PDA), tablet computer, peripheral input device, etc. having a touch-sensitive surface or display As illustrated in FIG. 1, the device 100 can include a mutual capacitive touch panel 102, a controller circuit 104, a host processor 106, input-output circuitry 108, memory 110, a display 112 (e.g., liquid crystal display (LCD), plasma, etc.), and a power source, such as a battery 114, to provide operating power.

The controller circuit 104 may include, but is not limited to the following components/elements: a digital touch subsystem 120; a processor 122; memory including persistent/read-only memory (ROM) 124 and read-write/random access memory (RAM) 126; a test circuit 128; and a timing circuit 130. In one embodiment, the controller circuit 104 may be implemented as a single integrated circuit including digital logic, memory, and/or analog functions.

The digital touch subsystem 120 may include a touch front end (TFE) 132 and a touch back end (TBE) 134. The respective functionalities implemented in the TFE 132 and the TBE 134 may vary in accordance with certain embodiments according to design considerations, requirements, and/or categorizations of front and back-end features. Additionally, the functionality of the TFE 132 and the TBE 134 may be implemented in hardware, software, and/or firmware components. The TFE 132 may detect capacitance of a capacitive sensor, in this instance, the capacitive touch-panel 102, and deliver a high signal-to-noise ratio (SNR) capacitive image, also referred to as a heatmap, to the TBE 134. The TBE 134 can be configured to utilize the heatmap to discriminate, classify, locate, and/or otherwise track an object(s) “touching” the capacitive touch panel 102, and report this information to the host processor 106. As utilized in the context of the present disclosure, the terms touch or touch event can refer to some form of contact (whether intended or inadvertent) with the capacitive touch panel 102 by, e.g., one or more fingers, portions of a hand, or other body parts of a user. As well, touch may refer to contact via a stylus or other object(s) with the capacitive touch panel 102.

The processor 122 of the controller circuit 104 can be configured to operate in response to data and instructions stored in memory (e.g. ROM 124 and/or RAM 126) to control the operation of the controller circuit 104. In one embodiment, the processor 122 may be implemented as a reduced instruction set computer (RISC) architecture, for example as implemented in an Advanced/Acorn RISC machine (ARM™) processor available from ARM Holdings. The processor 122 may receive data from and provide data to other elements of the controller circuit 104. For example, and in particular, ROM 124 may store firmware data and/or instructions which can be used by any of, e.g., the aforementioned elements of the controller circuit 104. Such data and/or instructions may be programmed at the time of manufacture of the controller circuit 104 for subsequent use, or may be updated or programmed after manufacture.

The timing circuit 130 can be configured to produce clock signals and/or analog, time-varying signals for use by one or more of the aforementioned elements of the controller circuit 104. The clock signals may include a digital clock signal for synchronizing digital components such as the processor 122, and the analog, time-varying signals may include signals of predetermined frequency and amplitude for driving, for example, the capacitive touch panel 104. Accordingly, in some embodiments, the timing circuit 130 may be thought of as operating under the control of, or responsive to, elements of the controller circuit 104, e.g., the processor 122 or the ROM 124.

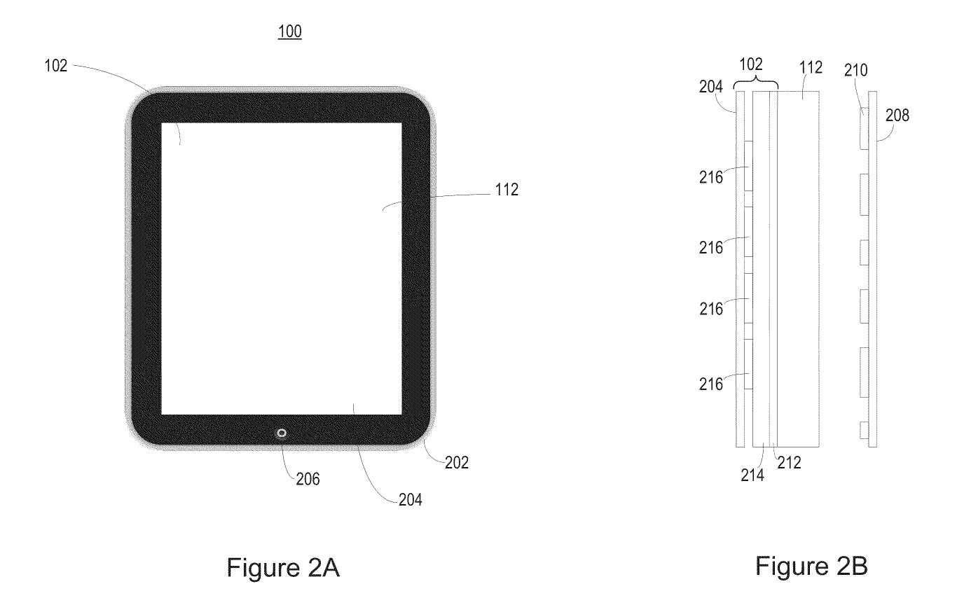

In accordance with one embodiment, the device 100 may be a tablet computer. FIG. 2A illustrates a top view of one example of the device 100, and FIG. 2B illustrates a cross-sectional view of one example of the device 100. The device 100 may include a housing 202, a lens or clear touch surface 204, and a control switch/button 206.

Contained within the housing 202 may be a printed circuit board 208, and circuit elements 210 arranged on the printed circuit board 208, such as the previously described circuits, elements, etc. illustrated in FIG. 1. The capacitive touch panel 102 may be arranged in a stacked formation including various layers, such as a clear touch surface 204, an-array of one or more drive lines 212, an insulator 214, and an-array of one or more sense lines 216. The drive line(s) 212 and the sense line(s) 216 can be arranged, e.g., perpendicularly, relative to each other, with the insulator 214 electrically isolating the drive line(s) 212 from the sense line(s) 216. Signals can be provided to the drive line(s) 212 and sensed by the sense line(s) 216 to locate a touch event on the clear touch surface 204, where the display 112 may be located between the printed circuit board 208 and the capacitive touch panel 102.

As illustrated in FIG. 2A, the capacitive touch panel 102 and the display 112 may be generally coextensive, and together may form a user interface for the device 100. For example, text, images, and/or other media, may be displayed on the display 112 for viewing and/or interaction by a user. The user may touch the capacitive touch panel 102 to control operation of the device 100 and/or control the display or playback of the text, images, and other media. Alternatively, the capacitive touch panel 102 may be implemented as a touch pad of a computing device, where the display 112 need not be coextensive (or co-located) with the capacitive touch panel 102. Rather, the display 112 may be located nearby for viewing by a user as he/she touches the capacitive touch panel 102 to control the computing device.

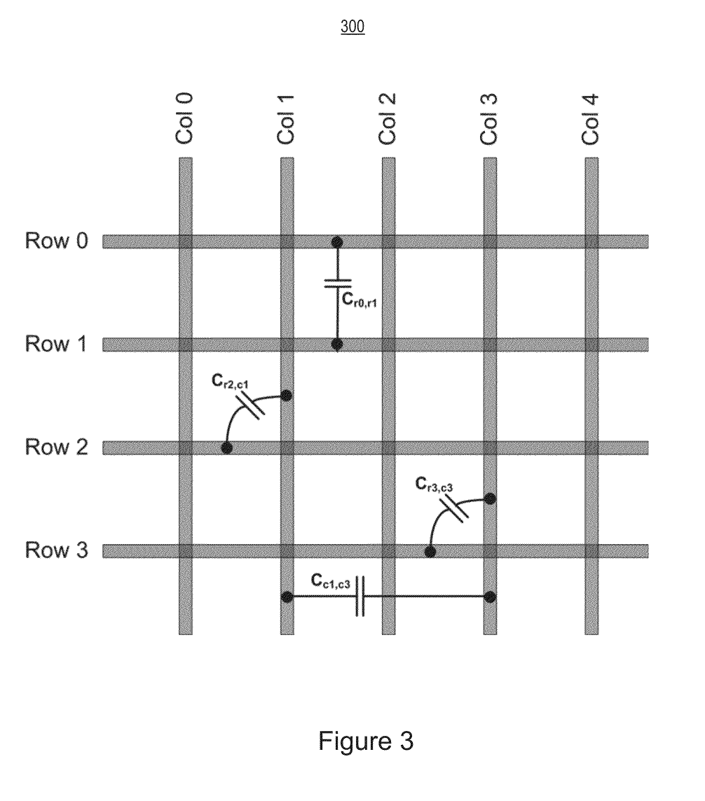

FIG. 3 illustrates an example configuration of drive and sense lines making up a mutual capacitive touch panel 300. The mutual capacitive touch panel 300 can model the capacitive touch panel 102 of FIG. 1, and may have N_{row} rows and N_{col} columns (e.g., N_{row}=4, N_{col}=5 in FIG. 3). In this manner, every intersection of each N_{row} rows and N_{col} columns in the mutual capacitive touch panel 300 can be a mutual capacitor and representative of a pixel having a characteristic mutual capacitance. When a voltage is applied to the N_{row} rows or N_{col} columns, a touch event occurring on the capacitive touch panel 102 changes the local electrostatic field resulting in a reduction of the mutual capacitance of one or more pixels. This change in mutual capacitance may be measured to, e.g., determine a touch event location. That is, the controller circuit 104 may use these mutual capacitances to sense touch, as they create a natural grid of capacitive nodes that the controller circuit 104 uses to create a heatmap. For example, the identification of one or more sense lines that experience a reduction in their mutual capacitance as well as one or more drive lines being driven by a signal at the time of reduction can be used to deduce the location of the touch event. It should be noted that there are a total of (N_{row}×N_{col}) nodes in the mutual capacitive touch panel 300.

A capacitive touch panel, such as the mutual capacitive touch panel 300, may be capable of being stimulated in a variety of different ways, where the manner of stimulation impacts which of the mutual capacitances within the mutual capacitive touch panel are measured. Described in greater detail below, are different operating sample modes indicative of the different ways in which, e.g., a touch front end, such as the TFE 132 of FIG. 1, can stimulate a capacitive touch panel, such as the mutual capacitive touch panel 300 of FIG. 3.

Row-column (RC) mode refers to one sample operating mode of a mutual capacitive touch panel. In RC mode, and when the aforementioned arrays of drive and sense lines are oriented perpendicularly, relative to each other, as in the example illustrated in FIG. 3, rows can be driven with transmit (TX) waveforms, while columns can be connected to receive (RX) channels of the TFE 132. Therefore, the capacitance of the mutual capacitors between the rows and the columns of a mutual capacitive touch panel may be detected, yielding an N_{row}×N_{col} heatmap. In the context of the mutual capacitive touch panel 300 illustrated in FIG. 3, the RC mode can measure the capacitance of the mutual capacitors C_{r<1>},_{c<j>}, where <i> and <j> are integer indices of rows 0-3 and columns 0-4, respectively. It should be noted that a column-row (CR) mode, (i.e., driving columns and sensing rows) can yield essentially the same results as the RC mode when the R and C electrodes are identically shaped. It should be noted, however, given an alternative configuration, the results may differ if the R and C electrodes have different patterns.

Referring back to FIG. 1, self-capacitance column (SC) mode is a self-capacitance operating mode that may be supported by an example capacitive touch panel 102. In SC mode, one or more columns can be simultaneously driven and sensed. As a result, the total capacitance of all structures connected to the driven column may be detected.

In column-listening (CL) mode, RX channels of the TFE 132 can be connected to the columns of an exemplary capacitive touch panel 102, while the rows of the exemplary capacitive touch panel 102 can be either be shorted to a low-impedance node (e.g., AC ground), or left floating (e.g., high-impedance) such that there is no transmission of TX waveforms. CL mode can be utilized for listening to any noise and interference present on the columns. The output of the RX channels can be fed to a spectrum estimation processor in order to determine the appropriate TX signal frequencies to use, and a desired interference filter configuration, as will be described in further detail below.

An exemplary TFE 132 can be configured to produce a heatmap by scanning all desired nodes/points of intersection of an exemplary capacitive touch panel 102 (e.g., all of the nodes, or some specified or relevant subset of all of the nodes). This process may be referred to as a frame scan, where the frame scan may run at a rate referred to as the frame rate or scan rate. The frame rate may be scalable. For example, frame scans may be run at a frame rate of 250 Hz for a single touch and a panel size less than or equal to 5.0 inches, 200 Hz for a single touch and a panel size greater than 5.0 inches, or 120 Hz for, e.g., ten touches and a panel size of 10.1 inches. An exemplary controller circuit 104 can be configured to support multiple frame rates, where the frame rate is configurable to maximize performance and power consumption for a given application.

An example controller circuit 104 may “assemble” a complete frame scan by taking a number of intermediate/step scans. Qualitatively, each step scan may result in a set of capacitive readings from the RX channels, though this may not be strictly done in all instances. The controller circuit 104 may perform each step scan at the same or different frame rate, referred to as a step rate. For an RC scan, where transmitters and receivers are connected to the rows and columns, respectively, of a mutual capacitive touch panel, N_{row} step scans could be run to create a full frame scan. Assuming that, e.g., the capacitive touch panel 102 of FIG. 1 is implemented in a tablet computer having 40 rows and 30 columns, the step rate may be at least 8 kHz to achieve a 200 Hz frame rate.

As previously alluded to, in a mutual capacitive touch panel, a touch event may cause a reduction in the mutual capacitance that is measured, such that the heatmap that is created by the TFE 132 will be directly proportional to the measured capacitance, causing a reduction in the heatmap.

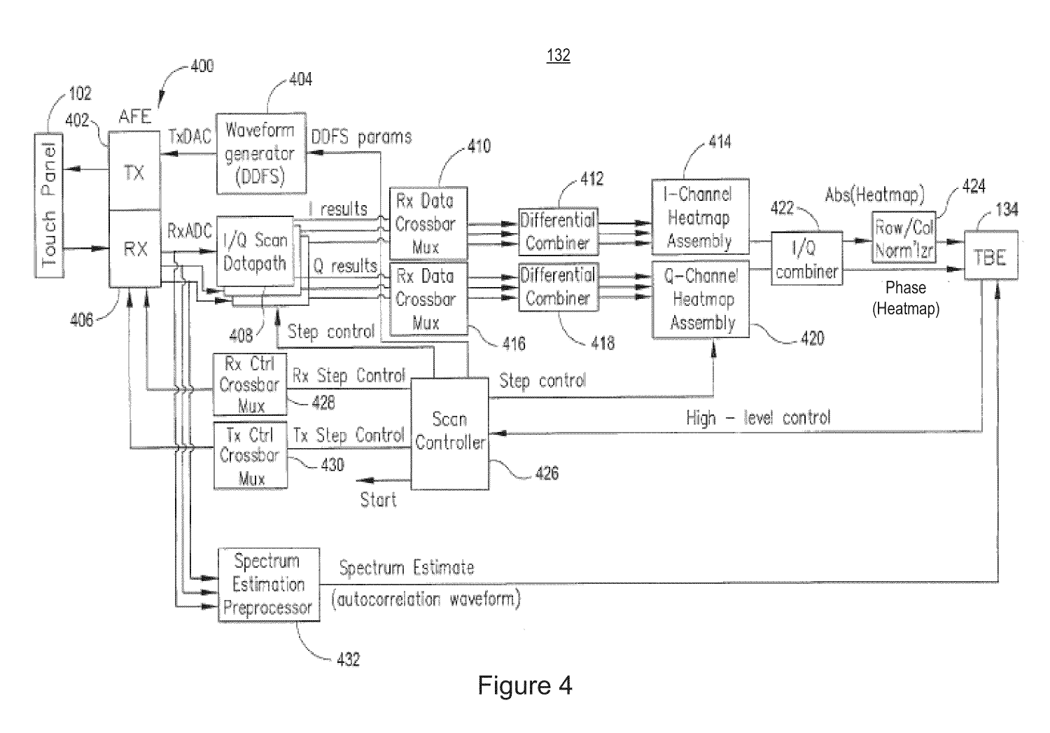

Referring to FIG. 4, a schematic representation of an example TFE 132 as shown in FIG. 1 is illustrated. The TFE 132 may include 48 physical TX channels connected to, e.g., the rows of the capacitive touch panel 102, and aggregated within a TX channel module 402, and 32 physical RX channels connected to, e.g., the columns of the capacitive touch panel 102, and aggregated within a RX channel module 406. Additionally, the TFE 132 may contain circuitry such as power regulation circuits, bias generation circuits, and/or clock generation circuitry (not shown). The TFE 132 may further include a direct digital frequency synthesis (DDFS) waveform generation module 404, and I/Q scan data paths 408. The TX channel module 402 and the RX channel module 406 may collectively be referred to as analog front end (AFE) 400. The TX channel module 402 can be configured to collectively provide signals to columns/rows of the capacitive touch panel 102, while the RX channel module 406 can be configured to collectively sense signals from the rows/columns of the capacitive touch panel 102.

The TX channel module 402 may further include a digital-to-analog converter (DAC), polarity control circuits, and/or buffers (not shown), while the RX channel module 406 may further include a pre-amplifier, and/or an analog-to-digital converter (ADC) (not shown). The TX channels may be driven by a shared TX data signal, and may each receive a common transmit DAC clock signal to drive the TX DAC. The clock signal may come directly from a frequency locked loop block within the TFE 132, and may be routed to the digital portion of the TFE 132.

Each physical TX channel may further have its own set of channel-specific TX control (TxCtrl) bits that appropriately control various parameters of the TX channel, such as enable/disable, polarity control, and/or gain/phase control. These TxCtrl bits may be updated between subsequent step scans during a frame scan operation. A control signal can be configured to control the transmit polarity of each of the 48 TX channels. As will be described in greater detail below, the polarity of the TX outputs may be modulated in an orthogonal sequence, with each TX output having a fixed polarity during each scan step during a frame scan.

All RX channels may receive a set of common clock signals that can be provided directly from a frequency locked loop block within the TFE 132. This clock signal can also be routed to the digital portion of the TFE 132, and include an RxADCC1k signal which drives the RX ADC. Like the physical TX channels, each physical RX channel may also have its own set of channel-specific receive control bits (i.e., RxCtrl bits) that appropriately control various parameters of the RX channel, such as enable/disable and/or gain control. These RX control bits can be updated between subsequent step scans during a frame scan operation. Additionally, there may be a shared set of control setting registers that control all RX channels simultaneously, as well as one or more reset lines, common to all reset channels, that may be asserted in a repeatable fashion prior to each scan step of a frame scan.

Moreover, the TFE 132 can include, for the in-phase (I) results from an I/Q scan data path, a receive data crossbar multiplexer 410, a differential combiner 412, and/or an in-phase channel heatmap assembly module 414. Similarly for the quadrature (Q) results, the TFE 132 can include a receive data crossbar multiplexer 416, a differential combiner 418, and a quadrature-phase channel heatmap assembly module 420. The in-phase results and the quadrature results can be combined in an I/Q combiner 422. The absolute value of the data can be provided to a row and column normalizer 424, and then made available to the TBE 134. Similarly, heatmap phase information from the I/Q combiner 422 can be provided to the TBE 134.

Further still, the TFE 132 may include a scan controller 426, an RX control crossbar multiplexer 428, a TX control crossbar multiplexer 430, and/or a spectrum estimation preprocessor 432, as will be described below in greater detail, for providing a spectrum estimate to the TBE 134. The scan controller 426 can be configured to receive high-level control signals from the TBE 134 to control which columns are provided with TX signals and which rows are sensed, or vice versa.

The RX data crossbar multiplexers 410 and 416, and the RX control crossbar multiplexer 428 together can form an RX crossbar multiplexer which could be used to logically remap the physical RX channels by remapping both their control inputs and data outputs. As such, the control signals routed to these multiplexers may be identical, as the remapping performed by the RX data crossbar multiplexers 410 and 416 and the RX control crossbar multiplexer 428 could be identical. This allows for logical remapping of electrical connectors, such as pins or balls, which connect an integrated circuit, which can include the controller circuit 104, to other circuit components of the device 100. This in turn may enable greater flexibility in routing a printed circuit board from the integrated circuit that includes the controller circuit 104 to the capacitive touch panel 102.

Since the I/Q scan data path 408 outputs complex results, the aforementioned RX crossbar multiplexer may be able to route both the I and Q channels of the I/Q scan data path 408 output by instantiating two separate and identical crossbar multiplexers, i.e., RX data crossbar multiplexers 410 and 416 that share the same control inputs. The RX control crossbar multiplexer 428 can be located between the scan controller 426 and the AFE 400 for remapping the per-channel RX control inputs going into the AFE 400. The structure of the RX control crossbar multiplexer 428 may be the same as that used for RX data crossbar multiplexers 410 and 416.

Because the RX control crossbar multiplexer 428 can be used in conjunction with the RX data crossbar multiplexers 410 and 416 to logically remap the RX channels, it may be programmed in conjunction with the RX data crossbar multiplexers 410 and 416. It should be noted that the programming of the RX control crossbar multiplexer 428 and the RX data crossbar multiplexers 410 and 416 are not necessarily identical. Rather, the programming may be effectuated such that the same AFE to controller channel mapping achieved in, e.g., the RX control crossbar multiplexer 428 multiplexer is implemented in, e.g., the RX data crossbar multiplexers 410 and 416.

The scan controller 426 may form a central controller that can be configured to facilitate scanning of the capacitive touch panel 102 and processing of output data in order to create a heatmap. The scan controller 426 may operate in response to control signals from the TBE 134. The scan controller 426 may support different scan modes, a few examples of which are described below, and where switching between modes can be performed at the request of the processor 122, with some exceptions.

A scan mode referred to as the active scan mode may be considered a standard mode of operation, where the controller circuit 104 actively scans the capacitive touch panel 102 in order to perform measurements to generate a heatmap. Regardless of what form of scan is utilized, the scan controller 426 can step through a sequence of step scans in order to complete a single frame scan.

In a single-frame mode, the controller circuit 104 can initiate one single frame scan at the request of the processor 122. After the scan is complete, heatmap data can be made available to the processor 122, and the scan controller 426 can suspend further operation until additional instructions are received from the processor 122. This mode can be useful in chip debugging.

In a single-step mode, the controller circuit 104 can initiate one single step scan at the request of the processor 122. After the scan is complete, the outputs of the I/Q scan data path 408 can be made available to the processor 122 and the scan controller 426 can suspend further operation until additional instructions are received from the processor 122. This mode can also be useful in chip debugging, as well as chip testing.

In an idle scan mode, a scan can be initiated by the processor 122 in order to run the controller circuit 104 in a lower-performance mode. Typically, this mode is selected when the processor 122 does not detect an active/current touch on the capacitive touch panel 102, but still desires a reasonably fast response to a new touch. Therefore, the processor 122 can remain active and capable of processing heatmap data produced by the TFE 132.

A few primary differences between the active scan mode and the idle scan mode are first, the frame rate in idle scan mode will typically be slower than that used in active scan mode. Duty cycling of the AFE 400 and other power reduction modes can be used in order to reduce total power consumption of the controller circuit 104 during idle scan. Second, the length of time used to generate a single frame scan may be shorter in idle scan mode than in active scan mode. This may be achieved by, among other ways, shortening the duration of a step scan or by performing fewer step scans per frame scan. Reducing total frame scan time may further reduce power (albeit at the expense of reduced heatmap SNR).

A spectrum estimation mode (SEM) may be used to measure the interference and noise spectrum coupling into the RX channels. In particular, the spectrum estimation preprocessor 432 can measure the background levels of interference that couple into the RX channels. Based on this measurement, the processor 122 of the controller circuit 104 may appropriately select TX frequencies that are relatively quiet or interference free, and calculate effective filter coefficients for the filters within the I/Q scan data path 408. This mode is typically used with the CL operating mode. At other times, when SEM is not needed, the spectrum estimation preprocessor 432 may be powered down.

It should be noted that when SEM is used, certain elements of the TFE 132 may be disabled. For example, the TX channel module 402 of the AFE 400 may be powered down, while the RX channel module 406 records background noise and interference signals that couple into the capacitive touch panel 102. The RX data from all of the RX channels can be routed to the spectrum estimation preprocessor 432, which can be configured to perform mathematical preprocessing on this data. The output of the spectrum estimation preprocessor 432 can be an N-point vector of 16-bit results, where N is approximately 200, which can then be handed off to the processor 122 for further analysis and determination of an appropriate TX frequency to use (described in greater detail below).

In addition to the scan modes described above, the controller circuit 104 may employ a set of sleep modes, where various functions/elements of the controller circuit 104 are disabled and/or powered down completely.

As previously described, a frame scan may include a series of step scans. The structure of each step scan may be identical from one step scan to the next within a given frame scan, although the exact values of control data may vary from step scan to step scan. Furthermore, the operation of a given frame scan may be determined by configuration parameters, and may or may not be affected by data values measured by the RX channels. One example of the frame scan logic that the controller circuit 104 may implement is shown below, where the incremental heatmap processing operation is described in greater detail below.

```
// Initialization
Set DDFS parameters;
Clear heatmap_memory;
// Step scan loop
For step_idx = 1 to num_step_scans {
            // Configure circuits according to step_idx
            scan_datapath_control to
            scan_datapath_parameters[step_idx];
            Assert Rx_reset and wait TBD clock cycles;
            Set AFE_control_inputs to AFE_parameters[step_idx];
            Deassert Rx_reset and wait TBD clock cycles;
            // Run step scan and collect data
            Send start signal to DDFS and scan data path;
            Wait for TBD clock cycles for step scan to complete;
            Pass datapath_results[step_idx] to heatmap assembly
            block
            // Incremental heatmap processing
} // step_idx loop
```

In order to achieve improved SNR in the heatmap, the controller circuit 104 may provide support for multi-transmit (multi-TX) stimulation of the capacitive touch panel 102. Multi-TX stimulation refers to simultaneously stimulating multiple rows of the capacitive touch panel 102 with a TX signal (or a polarity-inverted version of the TX signal) during each step scan of a complete frame scan. The number and polarity of the rows that are stimulated may be controlled through control registers in the AFE 400. The number of rows simultaneously stimulated during a multi-TX stimulation can be defined as a parameter Nₘᵤₗₜᵢ, which may be a constant value from step-to-step within a given frame and also from frame-to-frame.

If Nₘᵤₗₜᵢ rows are simultaneously stimulated during a step scan, it may take at least Nₘᵤₗₜᵢ step scans to resolve all of the pixel mutual capacitances being stimulated. Each receiver can have Nₘᵤₗₜᵢ capacitances being stimulated during a scan step, and hence, there can be Nₘᵤₗₜᵢ unknown capacitances, requiring at least Nₘᵤₗₜᵢ measurements to resolve those unknown capacitance values. During each of the Nₘᵤₗₜᵢ steps, the polarity control of the TX rows can be modulated, e.g., by a set of Hadamard sequences. Once this set of Nₘᵤₗₜᵢ (or more) step scans is complete, the next set of Nₘᵤₗₜᵢ rows can be stimulated in the same fashion, as Nₘᵤₗₜᵢ will likely be less than the number of actual rows in the capacitive touch panel 102.

Accordingly, the processing of the entire capacitive touch panel 102 may occur in blocks, where a first Nₘᵤₗₜᵢ rows of pixels can be resolved during a first batch of step scans, a second Nₘᵤₗₜᵢ rows of pixels can be resolved in a second batch of step scans, and so on, until all the rows of the capacitive touch panel 102 are fully resolved.

In some scenarios, the number of rows will not be an exact multiple of Nₘᵤₗₜᵢ. In such situations, the number of rows scanned during a final block of rows may be less than Nₘᵤₗₜᵢ. However, Nₘᵤₗₜᵢ scan steps may be performed on these remaining rows, using specified non-square Hadamard matrices.

A differential scan mode is an enhanced scanning mode, where the frame scan operation can be modified to exploit the correlation of the interference signal received across adjacent receive channels. In this scan mode, the number of step scans used to assemble a single frame scan can be doubled. Conceptually, each step scan in a scan sequence can become two step scans: the first step scan being a single-ended or “normal” step scan with the default values for the AFE control registers; and the second being a differential step scan.

Given N_{RX} receive channels, the differential scan mode may yield a total of 2N_{RX} receiver measurements per aggregate scan step (e.g., N_{RX} single-ended measurements and N_{RX} differential measurements). These 2N_{RX} measurements can be recombined and collapsed into N_{RX} normal measurements in the differential combiners 412 and 418.

The waveform generation module 404 can generate the TX waveform for use with the TX channels to drive either the rows or columns, as appropriate. The waveform generation module 404 may generates a digital sine wave, or other simple periodic waveforms; such as square waves having edges with programmable rise and fall times. The primary output of the waveform generation module 404 can be the data input to the TX channel module 402 (TxDAC). The waveform generation module 404 can receive as input signals, clock and start signals. Upon receiving a start signal from the scan controller 426, the waveform generation module 404 can begin producing digital waveforms for the duration of a single step scan. At the conclusion of the step scan, the waveform generation module 404 can cease operating and wait for the next start signal from the scan controller 426. It should be noted that the waveform generation module 404 may have some amount of amplitude control, although the waveform generation module 404 will typically be run at maximum output amplitude. It should further be noted that signal outputs may be in two complement format, and the waveform generation module 404 may also provide arbitrary sine/cosine calculation capabilities for the I/Q scan data path 408 and spectrum estimation preprocessor 432.

The differential combiner modules 412 and 418 may allow for operating in differential scan mode, where the RX channels alternate step scans between single-ended measurements and differential measurements. The purpose of the differential combiner modules 412 and 418 (akin to spatial filters) can be to combine the N_{RX} single-ended measurements and (N_{RX}−1) differential measurements into a single set of N_{RX} final results for use in the heatmap assembly modules 414 and 420 that follow.

The I and Q heatmap assemblies, modules 414 and 420, may take step scan outputs from the I/Q scan data path 408 or differential combiners 412 and 418, if used, and assemble a complete heatmap that can be the primary output of the frame scan operation. In assembling a complete heatmap, all of the step scan outputs may be mathematically combined in an appropriate manner to create estimates of the capacitance values of the individual capacitive pixels in the capacitive touch panel 102. It should be noted that heatmap assembly 414 is for I-channel data and heatmap assembly 420 is for Q-channel data, where each heatmap assembly may operate on either the I-channel or Q-channel data in order to create either an I-channel or a Q-channel heatmap.

The I/Q combiner 422 can be used to combine the I and Q-channel heatmaps into a single heatmap. The primary output of the I/Q combiner 422 can be a heatmap of the magnitude of the I and Q-channel heatmaps (e.g., Sqrt[I²+Q²]), which can be the heatmap that is handed off to the TBE 134.

The row/column normalizer 424 can be used to calibrate out any row-dependent or column-dependent variation in the panel response. The row/column normalizer 424 can have two static control input vectors, identified as RowFac and ColFac. RowFac can be an Nrow-by-1 vector, and ColFac can be an Ncol-by-1 vector, where each entry has the same dimensions as RowFac.

In one embodiment, the controller circuit 104 can have the capability to allow RowFac and ColFac to be defined either by one time programmable (OTP) bits or by a firmware configuration file. The OTP settings can be used if the manufacturing flow allows for per-module calibration, thus enabling the capability to tune the controller circuit 104 on a panel-by-panel basis. If RowFac and ColFac can only be tuned on in a per-platform basis, then the settings from a firmware configuration file can be used instead.

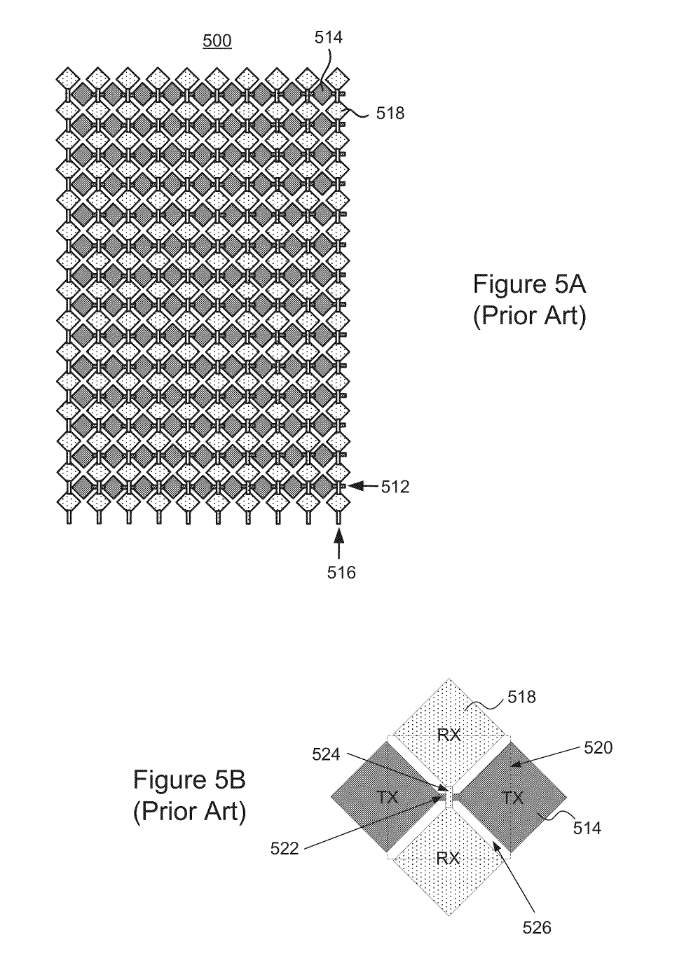

FIG. 5A illustrates a top view of an array of drive and sense electrodes of a mutual capacitive touch panel 500 configured similarly to that illustrated in FIG. 3. In accordance with the relative perpendicular orientation of drive and sense lines arrays described above with reference to FIG. 3, FIG. 5A also illustrates an array of drive lines 512 that are perpendicularly oriented to an array of sense lines 516. However, in the mutual capacitive touch panel 500, each drive line 512 may include a plurality of individual, diamond-shaped drive electrodes 514, which can be driven by TX waveforms (as described above) provided to each drive line 512. Likewise, each sense line 516 may include a plurality of individual sense electrodes 518, where the drive signals provided to drive electrodes 514 couple capacitively to sense electrodes 518 and produce corresponding sense signals, where again, the sense electrodes 518 are diamond-shaped. Drive lines 512 and sense lines 516, may include a transparent conductive material, for example, such as indium tin oxide (ITO).

FIG. 5B illustrates a close-up view of a unit cell (residing within unit cell boundary 520) of such a diamond sensor pattern, which includes the diamond-shaped drive electrodes 514 and sense electrodes 518. Bridges or jumpers, such as bridges 522 and 524, can be used to connect the drive electrodes 514 along drive line 512, and the sense electrodes 518 along sense line 516, respectively. Additionally, and within the unit cell boundary 520, open zones exist, e.g., open zone 526, which may occur as gaps between the drive electrodes 514 and the sense electrodes 518 in this example. Open zones can be regions across which electric field lines between TX and RX electrodes are formed.

Noise and interference can often affect the performance of capacitive touch panels, as alluded to previously. One specific type of noise that can present significant issues is charger noise, where the issues can range from reduced touch sensitivity/accuracy or linearity, false touches, or otherwise erratic behavior on the part of the capacitive touch panel. Charger noise can refer to noise that may be physically coupled or injected into a capacitive sensor (such as the capacitive touch panels 102, 300, or 500) during the presence of touch through some type of charging unit (e.g., battery charging unit, car charging unit, etc.) used to power and/or charge a device, such as the device 100. For example, after-market and/or budget chargers that can be used to charge a device having a capacitive touch panel may be manufactured with less quality control, inferior components, or even a lack of certain components (e.g., pulse width modulation control, Y capacitor to ground, etc.) found in original equipment manufacturer (OEM) charging units that can help control or mitigate the effects of charger noise. Accordingly, such charging units may be thought of as broadband noise generators (often with periodic noise tendencies with harmonics) that inject voltage into the capacitive touch panel, thereby disrupting its proper operation.

In particular, charger noise may couple to a capacitive touch panel through the capacitance between a sense (RX) electrode (e.g., a sense electrode 518 of FIG. 5A) and a user's finger, stylus, etc. For the purpose of description, this capacitance may be referred to herein as C_{FRX}, where charger noise can be considered to be directly proportional to C_{FRX}. When diamond sensor patterns, such as that illustrated in FIGS. 5A and 5B, are utilized in a capacitive touch panel, the C_{FRX} capacitance can be large. Thus, and in accordance with conventional capacitive touch panel technologies, combating the effects of noise, e.g., charger noise, rely on higher excitation voltages. That is, and because the generated SNR (e.g., from the TFE 132) is directly proportional to the voltage at which a capacitive touch panel may be driven, a high drive (TX) voltage may be used to drive the capacitive touch panel.

Another challenge that arises with the operation of capacitive touch panels is when the capacitive touch panel is not grounded/held by a user. That is, and when a user attempts to operate a device with a capacitive touch panel, e.g., device 100, without actually holding the device, such as if the user merely places the device on a surface such as a table, a common ground/voltage reference point fails to be created from the device (floating ground). Accordingly, sensitivity to touches can be weakened to the point that the ability to detect touches may be completely lost. Furthermore, and even if the ability to detect touches still exists, it may often become difficult to distinguish between intended touches and false touches. This issue too, is directly related to the C_{FRX} capacitance.

Still another issue involves noise from the display itself, e.g., display 112. That is, the display, such as an LCD panel, may also generate a significant amount of noise that may be directly conducted into a capacitive touch panel. This issue can be made worse because users and manufacturers have gravitated to a desire to have smaller and thinner device footprints, which often results in the capacitive touch panel being located close to the display (e.g., in-cell capacitive touch panels) as will be described in greater detail below. That is, noise from the display may be picked up by the RX channels (e.g., RX channels of the TFE 132) which in turn may directly affect the SNR/heatmap. Accordingly, the ability to detect touches may be reduced. Such display noise can be considered to be directly proportional to the capacitance between the common electrode (VCOM) of a display (e.g., thin film transistor (TFT)-LCD) and a sense (RX) electrode, which for the purpose of description, may be referred to as a C_{pRX} parasitic capacitance.

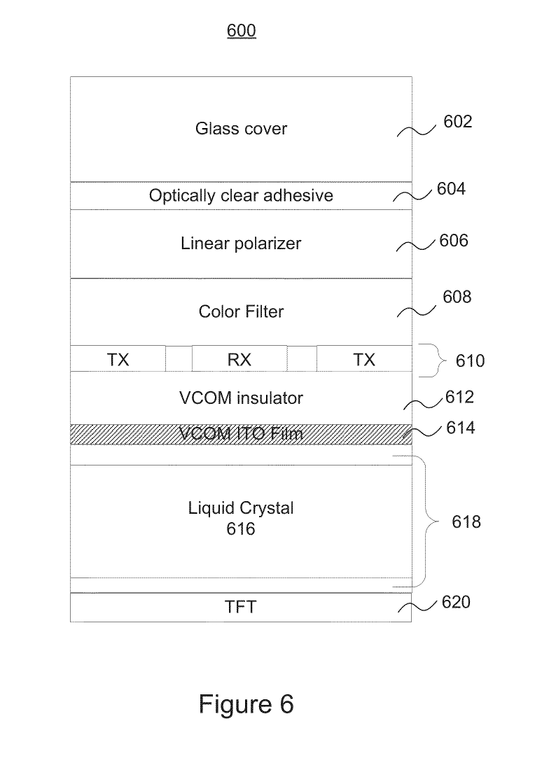

FIG. 6 illustrates a cross section of an example in-cell stack up configuration 600 in which a single layer sensor can be implemented. A glass cover 602 can be a first layer of the single layer sensor. Below the glass cover may be an optically clear adhesive layer 604 to bind the glass cover 602 to the other elements of the system, which can further include a linear polarizer 606, a color filter 608, the drive and sense electrodes 610, a VCOM insulator 612, VCOM ITO film 614, liquid crystal material 616 , and a thin film transistor (TFT) layer 620. The liquid crystal material 616 may generally be sandwiched between a pair of glass layers 618. Such a configuration may be referred to as “in-cell,” which can loosely refer to the implementation of sensors (e.g., drive and sense electrodes 610) below a color filter (e.g., color filter 608). It should be noted that the example configuration of FIG. 6 is presented to illustrate a scenario in which a capacitive touch panel may be located close to a display's active components, and therefore, there can be additional (or less) layers/components not necessarily shown that may be utilized in accordance with such a configuration.

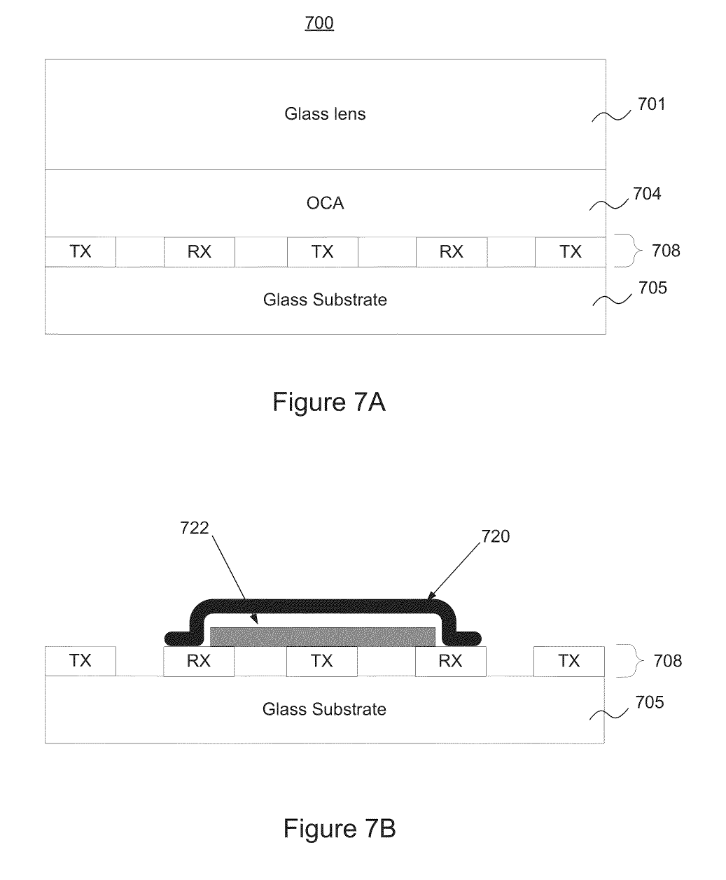

FIG. 7A illustrates a cross section of an example stand-alone single layer sensor 700, which may be an example of the single layer sensor of FIG. 6, that can be placed atop a display. The stand-alone single layer sensor 700 may include a glass lens 701 and optically clear adhesive layer 704. The optically clear adhesive layer 704 may bond the glass lens 701 to the glass substrate 705. FIG. 7B illustrates, in greater detail, the connections between the sense electrodes shown in FIG. 7A. That is, the sense (RX) electrodes may be connected by a bridge or jumper 720, while the drive (TX) electrodes may be connected by a bridge or jumper 722. It should be noted that the components of the sense electrodes are electrically connected (using bridge 720) without making any contact with the drive electrodes.

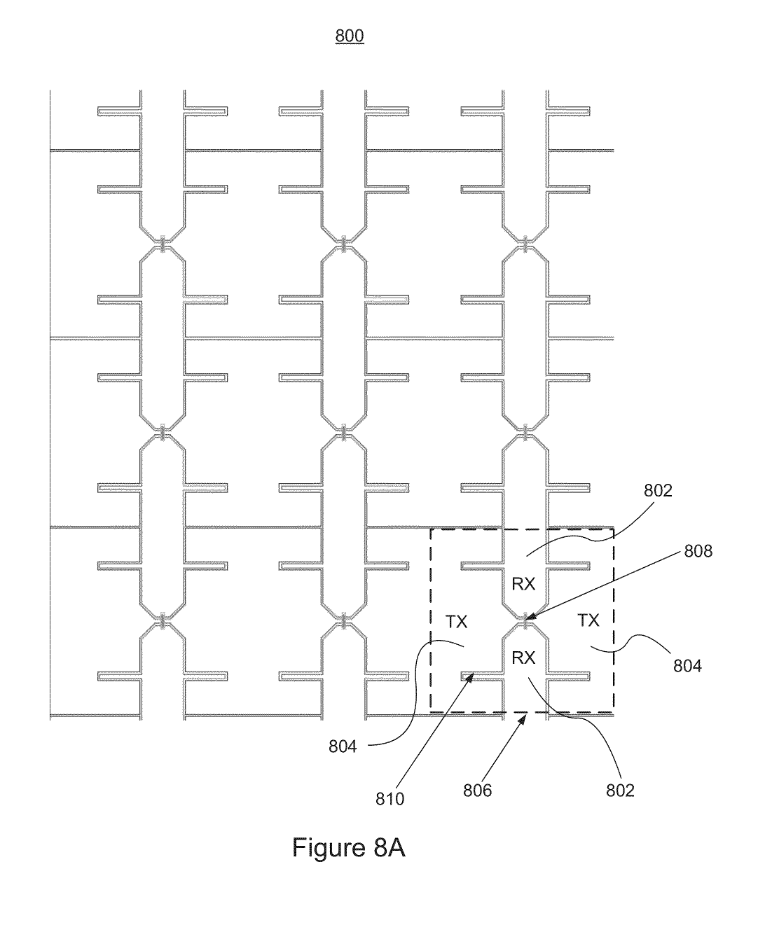

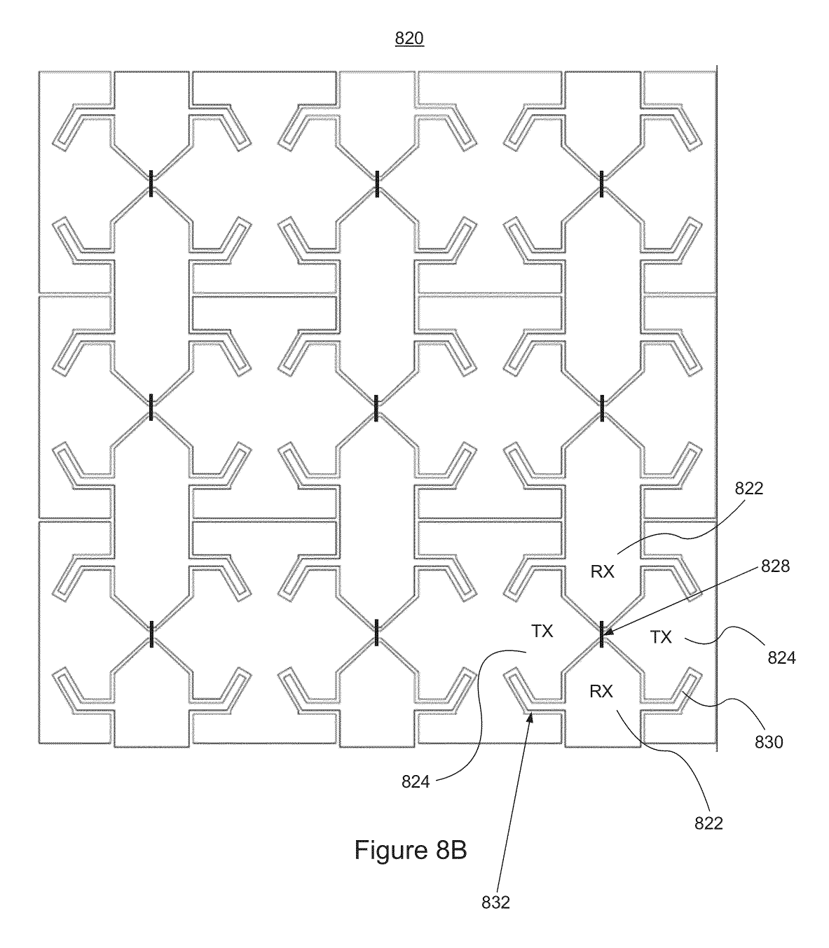

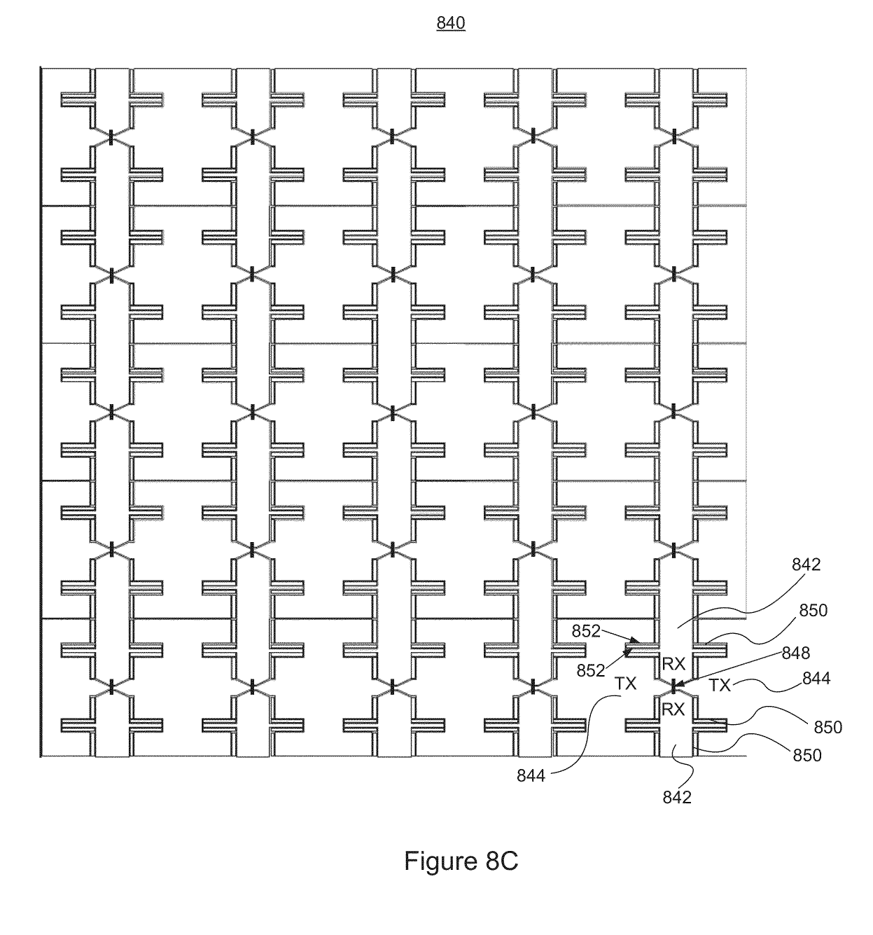

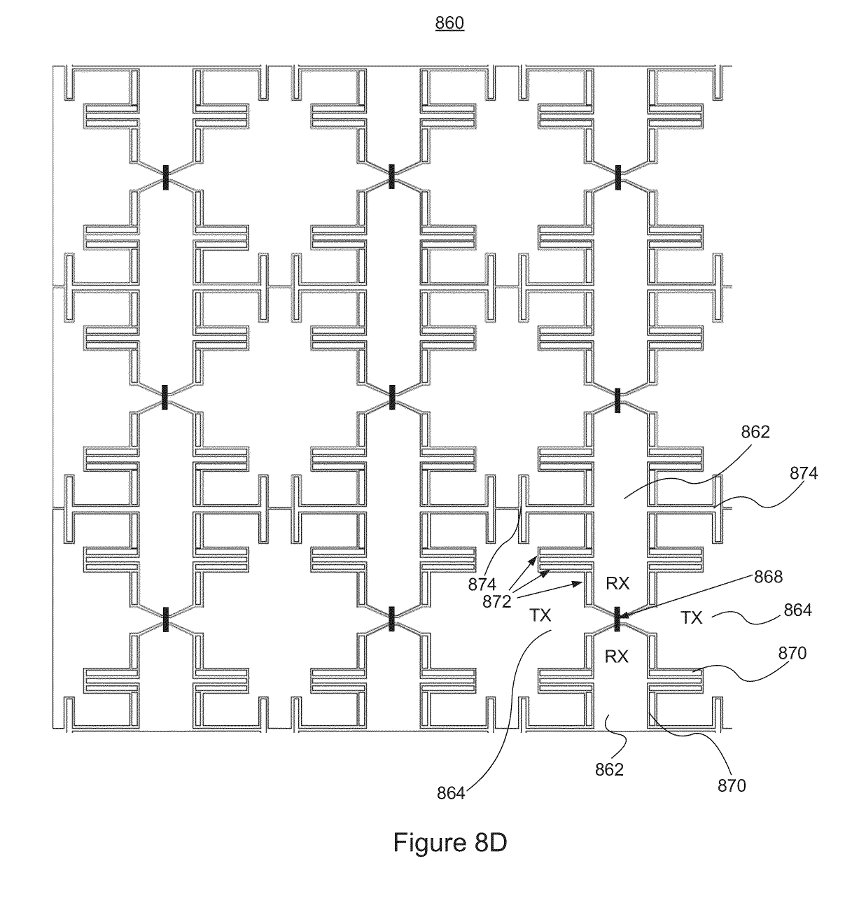

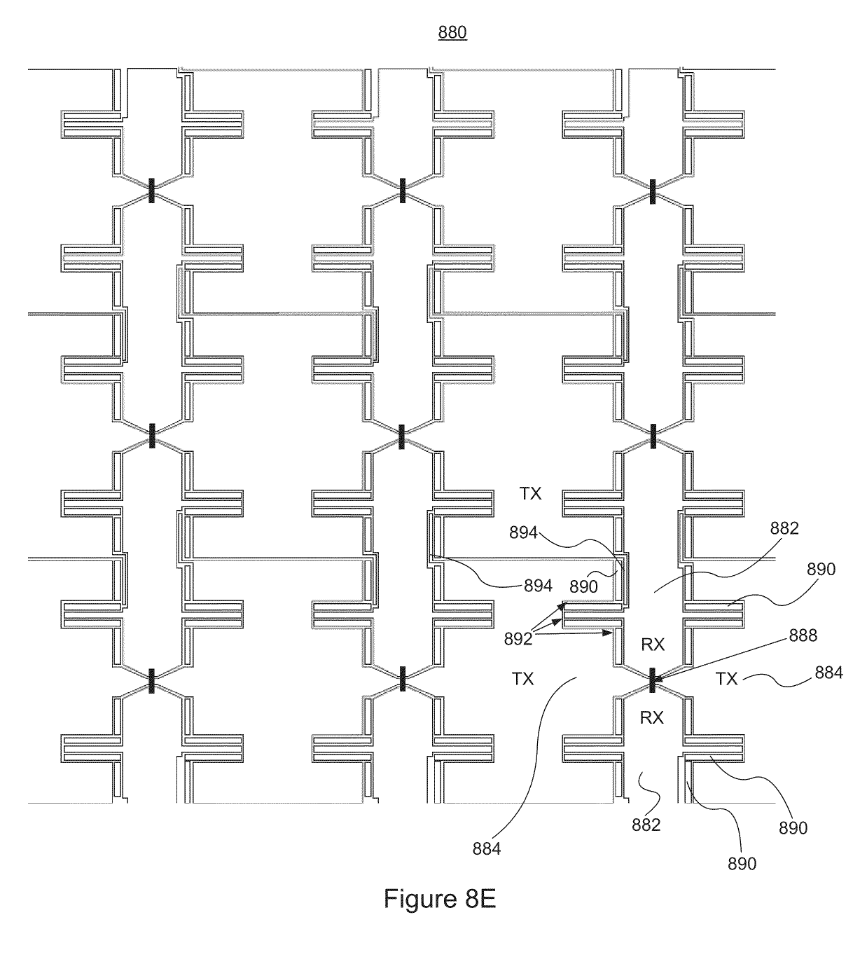

The aforementioned issues can be particularly problematic for capacitive touch panels that rely on symmetric sensor patterns, such as the diamond sensor pattern described above, where the drive and sense line arrays (and electrodes) occupy the same amount of space within a capacitive touch panel. However, these issues, e.g., charger noise, display noise, and floating may be addressed by an asymmetric sensor pattern as disclosed herein in accordance with various embodiments. FIG. 8A illustrates an example asymmetric sensor pattern 800 where sense (RX) electrodes are minimized such that the area occupied by each sense (RX) electrode 802 is much less than the area occupied by each drive (TX) electrode 804, while maintaining good/without sacrificing touch responsiveness. A unit cell boundary line 806 delineates a unit cell of the asymmetric sensor pattern disclosed herein. The sense (RX) electrodes 802 are shown to be shaped as an elongated element having one or more (in this example, two) sets of narrowly-shaped protrusions or “wings” extending substantially perpendicularly therefrom. These wings can increase the field interaction area, as well as provide increased response/sensitivity to touches between neighboring sense (RX) electrodes. Such an asymmetric sensor pattern may be utilized in conjunction with, e.g., single substrate sensors that utilize a bridge or jumper, such as bridge 808, for connecting sense (RX) electrodes, such as sense (RX) electrodes 802, where the bridge 808 may be made of a metal connector over a dielectric material to prevent any unwanted short circuiting (and resulting in a sense line). Alternatively, the bridge 808 may be made using ITO instead of metal. Moreover, the sense (RX) and drive (TX) electrodes may be separated by a boundary/gap 810, which will be discussed in greater detail below.

It should be noted that the angle at which the sets of wings extend from the elongated element of the sense (RX) electrodes 802 can vary in accordance with other embodiments, as well as whether such angles are consistent amongst each of the wings/sets of wings, or different. Moreover, the orientation of the sense (RX) electrodes 802 and the drive (TX) electrodes 804 can be altered in accordance with still other embodiments. For example, a unit cell of the asymmetric sensor pattern 800 may have the sense (RX) electrodes 802 running horizontally rather than vertically, while the drive (TX) electrodes 804 may run vertically rather than horizontally. Further still, the actual number of wings, as well as the size and shape of the wings, and even the size and shape of the elongated element may vary in accordance with yet other embodiments, while remaining consistent with the aforementioned minimization of the sense (RX) electrode area relative to the drive (TX) electrode area, and maintaining touch sensitivity.

FIG. 8B illustrates another example asymmetric sensor pattern 820 where, again, sense (RX) electrodes are minimized such that the area occupied by each sense (RX) electrode 822 is much less than the area occupied by each drive (TX) electrode 824. Like the asymmetric sensor pattern 800 of FIG. 8A, the asymmetric sensor pattern 820 may be utilized in conjunction with, e.g., single substrate sensors that utilize a bridge or jumper, such as bridge 828, for connecting sense (RX) electrodes 822, where the bridge 828 may be made of a metal connector over a dielectric material, for example, to prevent any unwanted short circuiting. Again, and alternatively, the bridge 828 may be made using ITO instead of metal. Further, like the asymmetric sensor pattern 800 of FIG. 8A, the sense (RX) electrodes 822 are shown to be shaped as an elongated element having one or more sets of narrowly shaped protrusions or “wings” extending substantially perpendicularly therefrom. These wings can increase the field interaction area, as well as provide increased response/sensitivity to touches between neighboring sense (RX) electrodes. However, rather than the substantially straight wings of sense (RX) electrodes 802, the wings of sense (RX) electrodes 822 are configured to be “elbow” shaped. Utilization of such elbow shaped protrusions can create more areas/increase the area for, e.g., finger/stylus interaction. This can be helpful when a user's finger is small or in the case of stylus, which has a small point/area, which can be utilized to interact with a capacitive touch panel. Also and again, the sense (RX) and drive (TX) electrodes 822 and 824, respectively, may be separated by boundary/gap 832.

FIG. 8C illustrates still another example asymmetric sensor pattern 840. The asymmetric sensor pattern 840 may utilize a bridge or jumper 848 for connecting sense (RX) electrodes 842 and drive (TX) electrodes 844. Again, the asymmetric sensor pattern 840 may be utilized in conjunction with, e.g., single substrate sensors that utilize the bridge 848, which can be made of a metal connector or ITO over a dielectric material. Also like the asymmetric sensor pattern 800 of FIG. 8A, the sense (RX) electrodes 842 are shown to be shaped as an elongated element having one or more sets of narrowly shaped protrusions or “wings” extending substantially perpendicularly therefrom. However, and in addition to the wings, asymmetric sensor pattern 840 may utilize “dummy” or “floating” electrodes 850 that do not touch/come in contact with the sense (RX) electrodes 842 or the drive (TX) electrodes 844 thereby remaining electrically isolated from each other. Such dummy or floating electrodes 850 are separated from the sense (RX) electrodes 842 and the drive (TX) electrodes 844 by a boundary/gap 852, as are the sense (RX) electrodes 842 and drive (TX) electrodes 844, themselves.

FIG. 8D illustrates yet another example asymmetric sensor pattern 860. The asymmetric sensor pattern 860 can be utilized in conjunction with a single substrate sensor, for example, that can utilize bridges/jumpers, e.g., bridge 868, to connect sense (RX) electrodes 862 to drive (TX) electrodes 864. Similar to the asymmetric sensor pattern 840 of FIG. 8C, the asymmetric sensor pattern 860 may be configured with a plurality of wings extending substantially perpendicularly from the sense (RX) electrodes 824, about which dummy or floating electrodes 870 can be utilized, where the dummy/floating electrodes 870, as well as the sense (RX) electrodes 862 and drive (TX) electrodes 864 can be separated by a boundary/gap 872. Moreover, the asymmetric sensor pattern 860 can be configured to have additional “T-shaped” protrusions/wings 874 extending from the sense (RX) electrodes 874, which can create still more/greater area for finger/stylus interaction.

FIG. 8E illustrates still another example asymmetric sensor pattern 880. The asymmetric sensor pattern 880 can be utilized in conjunction with a single substrate sensor, for example, that can utilize bridges/jumpers, e.g., bridge 888, to connect sense (RX) electrodes 882 to drive (TX) electrodes 884. Similar to the asymmetric sensor pattern 840 of FIG. 8C, the asymmetric sensor pattern 880 may be configured with a plurality of sets of wings extending substantially perpendicularly from the sense (RX) electrodes 884, about which dummy or floating electrodes 890 can be utilized, where the dummy/floating electrodes 890, as well as the sense (RX) electrodes 882 and drive (TX) electrodes 884 can be separated by a boundary/gap 892. Moreover, the asymmetric sensor pattern 880 can be configured to have additional extensions 894 that may protrude from the drive (TX) electrodes 884 that may abut against, e.g., at least one area of the elongated portion of a neighboring sense (RX) electrodes 882 and dummy/floating electrode 890 resulting in still additional finger/stylus interaction areas.

In symmetric sensor patterns, such as the diamond sensor pattern (and like derivatives) described above and illustrated in FIGS. 5A and 5B, the sense (RX) and drive (TX) electrodes (518 and 514) occupy the same or substantially similar areas. Accordingly, the capacitance between, e.g., a user's finger, stylus, etc., and the sense (RX) and drive (TX) electrodes are equal or at least almost the same, and a relatively large capacitance C_{FRX} can result due to greater coverage. Because, as described above, charger noise may couple to the capacitive touch panel through the capacitance between a sense (RX) electrode and a user's finger, stylus, etc., and because charger noise can be considered to be directly proportional to C_{FRX}, the noise may also be large.

The same may hold true with respect to the C_{pRX} parasitic capacitance between the sense (RX) electrodes and the VCOM of a display, for example, sense (RX) electrodes 608 and the VCOM of FIG. 6. That is, and again, display noise injected into the capacitive touch screen may also be large.

Further still, and with regard to the floating ground issue, the effect of a touch on a capacitive touch panel can be reduced when a device in which the capacitive touch panel is used is not being held, for example. That is, and because a solid ground is not created, the change in mutual capacitance created by a touch (which may be used to, e.g., determine a touch event location) is weakened, making touch detection or distinguishing between actual and false touch events more difficult.

However, by minimizing the area occupied by each sense (RX) electrode 802 relative to each drive (TX) electrode 804 in accordance with various embodiments, both capacitances C_{FRX} and C_{pRX} can be reduced. Because, as described above, noise, such as charger noise or noise from a display are directly proportional to these capacitances, respectively, a reduction in capacitance can equate to a reduction in noise. In the case of charger noise, for example, a reduction in the coupling between a user's finger, stylus, etc. due to a reduction in sense (RX) electrode area, can result in a reduced C_{FRX} capacitance. In some instances, utilization of an asymmetric sensor pattern as described herein may lead to charger noise reduction by a factor of two or more. Similarly, a reduction in the sense (RX) electrode area can reduce the coupling between the sense (RX) electrode and the VCOM of a display, also leading to a reduction in parasitic C_{pRX} capacitance. Again, and in some instances, utilization of an asymmetric sensor pattern as described herein may lead to display noise reduction by a factor of two or more. Further still, reducing the size of sense (RX) electrodes, which can lead to a reduced C_{FRX} capacitance, suggests that a touch event occurring when no solid ground has been created, e.g., when a user is not holding a device in which a capacitive touch panel is implemented, can still generate a sufficient change in the mutual capacitance. That is, when a user holds a device in which a capacitive touch panel is implemented, the user has a strong capacitive coupling to the device, and therefore, the device may be considered to be connected to a solid ground. When the user is not holding the device, only a floating (capacitive) ground to earth exists.

Moreover, and as described above, the asymmetric sensor pattern disclosed herein, while reducing the area of the sense (RX) electrodes, may still maintain good touch sensitivity. That is, and as a result of the wings protruding from the elongated element, the amount of touch-induced signals (that arise from a finger, stylus, etc. interacting with the capacitive touch panel) reaching a neighboring sense (RX) electrode may be extended.

Further to the above, a highly concentrated electrical field may be present within an open zone, such as a boundary/gap, e.g., boundary/gap 810 between the sense (RX) electrodes 802 and the drive (TX) electrodes 804 of FIG. 8A. That is, and in order to increase the bandwidth of the capacitive touch panel/touch sensor it may be beneficial to keep initial capacitance between RX and TX electrodes low. For example, the initial capacitance of the unit cell illustrated in FIG. 8A may be predominantly determined by the width of the boundary/gap between TX and RX electrodes, and the areas of the TX and RX electrodes. In accordance with various embodiments, it has been contemplated that an initial capacitance of a unit cell may be kept low while maintaining the change of this capacitance, e.g., due to finger presence, high. For example, the gap width between TX and RX electrodes may be in the range of, e.g., 30 to 100 um, although even smaller gap widths, e.g., 10 um are contemplated herein, where even in large sensor implementations, the initial capacitance may still be kept low

In accordance with various embodiments, an asymmetric sensor pattern may be utilized for the sense and drive electrodes of sense and drive lines in a capacitive touch panel, where the sense electrodes are much smaller than the drive electrodes. This difference in electrode size/area occupied can be leveraged to reduce the amount of capacitance between a finger, stylus, etc. and a sense electrode, and accordingly, reduce the noise from a charger unit. The difference in electrode size/area occupied can also be exploited by reducing display noise in implementations where the capacitive touch panel is located near/at/within a display portion. Further still, various embodiments can mitigate issues related to a lack of solid ground, again due to the reduced size of the sense (RX) electrode relative to the drive (TX) electrode, by increasing, e.g., finger response in neighboring electrodes when a finger is positioned away from such neighboring electrodes, through the use of one or more narrowly-shaped protrusions/extensions of the sense (RX) electrode.

The various diagrams illustrating various embodiments may depict an example architectural or other configuration for the various embodiments, which is done to aid in understanding the features and functionality that can be included in those embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality is presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An apparatus, comprising:
a plurality of drive lines extending along the apparatus in a first direction, each of the plurality of drive lines including a plurality of drive electrodes; and
a plurality of sense lines extending along the apparatus in a second direction substantially perpendicular to the first direction, each of the plurality of sense lines including a plurality of sense electrodes, wherein the plurality of drive electrodes and the plurality of sense electrodes are asymmetrically shaped, and wherein each of the plurality of sense electrodes comprises a single elongated element and a plurality of protruding elements oriented in accordance with at least one angle relative to the elongated element.

2. The apparatus of claim 1, wherein sizing of each of the plurality of sense electrodes is substantially less than sizing of each of the plurality of drive electrodes.

3. The apparatus of claim 1, wherein a perimeter of the plurality of drive electrodes substantially surrounds a perimeter of the plurality of sense electrodes.

4. The apparatus of claim 3, wherein the perimeter of the plurality of drive electrodes and the perimeter of the plurality of sense electrodes are separated by an open zone having a highly concentrated electrical field.

5. The apparatus of claim 1, wherein the plurality of drive electrodes and the plurality of sense electrodes are electrically disconnected.

6. The apparatus of claim 1, wherein the plurality of drive lines and the plurality of sense lines are constructed from a transparent conductive material.

7. The apparatus of claim 1, wherein each of the plurality of protruding elements is substantially narrower in width and substantially shorter in length relative to the elongated element.

8. The apparatus of claim 1, wherein at least two of the plurality of sense electrodes are connected via a bridge comprising a metal connector over a dielectric material.

9. The apparatus of claim 1, wherein each of the drive electrodes comprises at least one substantially narrow extension.

10. An apparatus, comprising:
a first array of drive lines, and
a second array of sense lines oriented perpendicularly to the first array of drive lines, wherein the amount of area occupied by the first array of drive lines is substantially greater than the amount of area occupied by the second array of drive lines within the apparatus, and wherein each of the sense lines comprises a series of connected singular elongated elements and a plurality of protruding elements oriented in accordance with at least one angle relative to the series of connected singular elongated elements.

11. The apparatus of claim 10, wherein the first array of drive lines comprises a plurality of drive electrodes, and wherein the second array of sense lines comprises a plurality of sense electrodes, each of the plurality of sense electrodes comprising one of the singular elongated elements and at least four of the plurality of protruding elements.

12. The apparatus of claim 11, wherein each of the plurality of sense electrodes is shaped dissimilarly from each of the plurality of drive electrodes.

13. The apparatus of claim 11, wherein each of the plurality of sense electrodes along a sense line are connected via a metal bridge over dielectric material.

14. The apparatus of claim 11, wherein a perimeter of the plurality of drive electrodes substantially surrounds a perimeter of the plurality of sense electrodes.

15. The apparatus of claim 11, wherein the first array of drive lines and the second array of sense lines comprise a transparent conductive material.

16. The apparatus of claim 11, wherein each of the plurality of protruding elements is substantially narrower in width and substantially shorter in length relative to the elongated element.

17. An apparatus, comprising:
a first array including a plurality of drive electrodes, and
a second array including a plurality of sense electrodes, the first array and the second array forming a capacitive touch panel, wherein a unit cell of the capacitive touch panel includes at least a portion of one of the plurality of sense electrodes and at least a portion of one of the plurality of drive electrodes, the one of the plurality of sense electrodes and the one of the plurality of drive electrodes being asymmetrically shaped.

18. The apparatus of claim 17, wherein a portion of the plurality of sense electrodes are connected by a plurality of metal bridges over dielectric materials to form a sense line.

19. The apparatus of claim 17, wherein each of the plurality of sense electrodes comprises an elongated element and a plurality of protruding elements oriented in accordance with at least one angle relative to the elongated element, and wherein each of the plurality of protruding elements is substantially narrower in width and substantially shorter in length relative to the elongated element.

20. The apparatus of claim 17 further comprising, a plurality of electrically isolated dummy electrodes.
